(19) United States
(12) Patent Application Publication
(10) Pub. No.: US 2025/0286862 A1
(43) Pub. Date: Sep. 11, 2025

(54) SWITCH

(71) Applicant: Nippon Telegraph and Telephone Corporation, Tokyo (JP)

(72) Inventors: Kenji Tanaka, Tokyo (JP); Yuki Arikawa, Tokyo (JP); Tsuyoshi Ito, Tokyo (JP); Naoki Miura, Tokyo (JP); Takeshi Sakamoto, Tokyo (JP); Yusuke Muranaka, Tokyo (JP)

(21) Appl. No.: 18/860,113

(22) PCT Filed: Jun. 9, 2022
(86) PCT No.: PCT/JP2022/023290

§ 371 Date: Oct. 25, 2024

(51) Int. Cl. H04L 9/40

(52) U.S. Cl. CPC H04L 63/0272; H04L 63/0263

(57) ABSTRACT

A switch is a switch configured to relay data transmitted and received between virtual private network (VPN) peers. The switch includes a first circuit that encrypts a packet from any one of computers as one of the VPN peers and transmits the packet after the encryption to any one of computers as the other of the VPN peers via a network to transmit the packet by a VPN. With such a configuration, encryption in a VPN is implemented without use of CPU resources of a server.

### CROSS-REFERENCE TO RELATED APPLICATIONS

This application is a national phase entry of PCT Application No. PCT/JP2022/023290, filed on Jun. 9, 2022, which application is hereby incorporated herein by reference.

### TECHNICAL FIELD

The present invention relates to a switch used for a network.

### BACKGROUND

There is known a technique of managing the operation of a virtual private network (VPN) by utilizing a centralized control plane of a software defined network (SDN) (Non Patent Literature 1). In such a technique, transmission data transmitted and received by a VPN is encrypted or decrypted by an application server.

### CITATION LIST

### Non Patent Literature

Non Patent Literature 1: Yunchun LI, Jutao MAO, “SDN-based access authentication and automatic configuration for IPSec”, 2015 4th International Conference on Computer Science and Network Technology (ICCSNT 2015)

### SUMMARY

### Technical Problem

When a central processing unit (CPU) of a server such as an application server is used for encryption and decryption for a VPN, it is conceivable that the encryption and decryption affect execution of another application by the CPU.

Embodiments of the present invention have been made in view of the above points, and an object thereof is to implement encryption in a VPN without use of CPU resources of a server.

### Solution to Problem

In order to solve the above problem, a switch according to embodiments of the present invention is a switch configured to relay data transmitted and received between a first combination of virtual private network (VPN) peers, the switch including a first circuit that encrypts 1-1 data from a 1-1 device as one of the first combination of VPN peers or causes an application specific integrated circuit (ASIC) or a field-programmable gate array (FPGA) of a network interface connected to the switch to encrypt the 1-1 data, and transmits the 1-1 data after the encryption to a 1-2 device as another of the first combination of VPN peers via a network to transmit the 1-1 data by a VPN.

### Advantageous Effects

According to embodiments of the present invention, encryption in a VPN is implemented without use of CPU resources of a server.

### BRIEF DESCRIPTION OF THE DRAWINGS

FIG. 1 is a configuration diagram of a communication system of a VPN including a switch according to a first embodiment of the present invention.

FIG. 2 is a configuration diagram of the switch in FIG. 1.

FIG. 3 is a configuration diagram illustrating details of a first packet processing circuit in FIG. 2.

FIG. 4 is a configuration diagram illustrating details of a second packet processing circuit in FIG. 2.

FIG. 5 is a configuration diagram of a switch according to a second embodiment of the present invention.

FIG. 6 is a configuration diagram illustrating details of a first packet processing circuit in FIG. 5.

FIG. 7 is a configuration diagram illustrating details of a second packet processing circuit in FIG. 5.

### DETAILED DESCRIPTION OF ILLUSTRATIVE EMBODIMENTS

Hereinafter, embodiments of the present invention will be described with reference to the drawings.

### First Embodiment

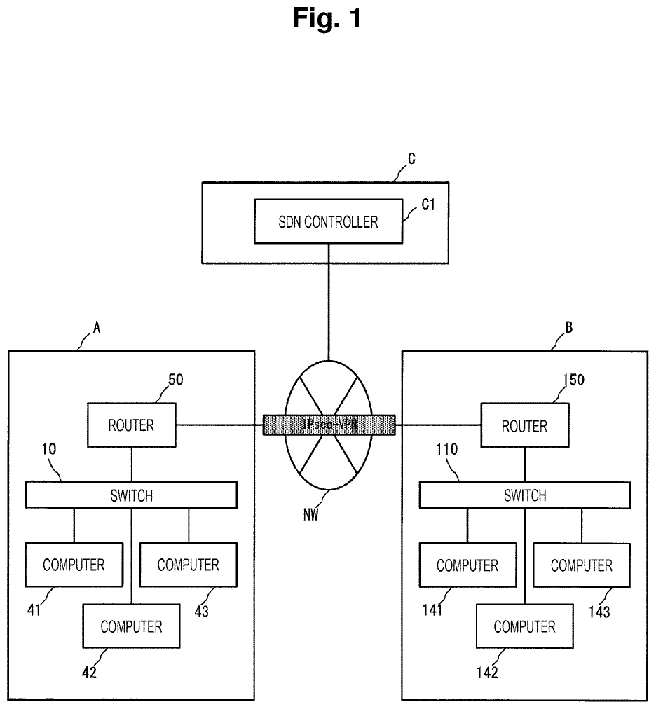

As illustrated in FIG. 1, a plurality of computers 41 to 43 are connected to a switch 10 according to a first embodiment of the present invention, and a router 50 connected to a network NW such as the Internet is connected to the switch 10. The switch 10, the plurality of computers 41 to 43, and the router 50 are installed in a site A.

A switch 110, a plurality of computers 141 to 143, and a router 150 are arranged in a site B, which is different from the site A. The switch 110 has a configuration similar to the switch 10, is connected to the plurality of computers 141 to 143, and is connected to the router 150 connected to the network NW.

The computers 41 to 43 are, for example, host or client computers or the like, and can communicate with each other via the switch 10. Furthermore, the computers 41 to 43 can communicate with the computers 141 to 143 via the router 50, the network NW, the router 150, and the switch 110. In particular, in the present embodiment, communication using an IPsec (Security Architecture for Internet Protocol)-VPN (virtual private network) is possible. Hereinafter, an IPsec-VPN is also simply referred to as a VPN. A pair of any one of the computers 41 to 43 and any one of the computers 141 to 143 that perform communication by a VPN constitutes VPN peers. The switch 10 and the switch 110 are configured to relay data transmitted and received between a plurality of combinations of VPN peers.

In a site C, a software defined network (SDN) controller C1 that integrally manages the switches 10 and 110, the routers 50 and 150, and the like, which are communication devices in the sites A and B, is arranged. The SDN controller C1 is connected to the network NW via a router (not illustrated) or the like.

In this embodiment, encryption and decryption necessary for VPN communication are performed by the switches 10 and 110. This enables VPN communication that does not use CPU resources of various servers. The switch 10 and the switch 110 have similar configurations. The switch 10 will be described below.

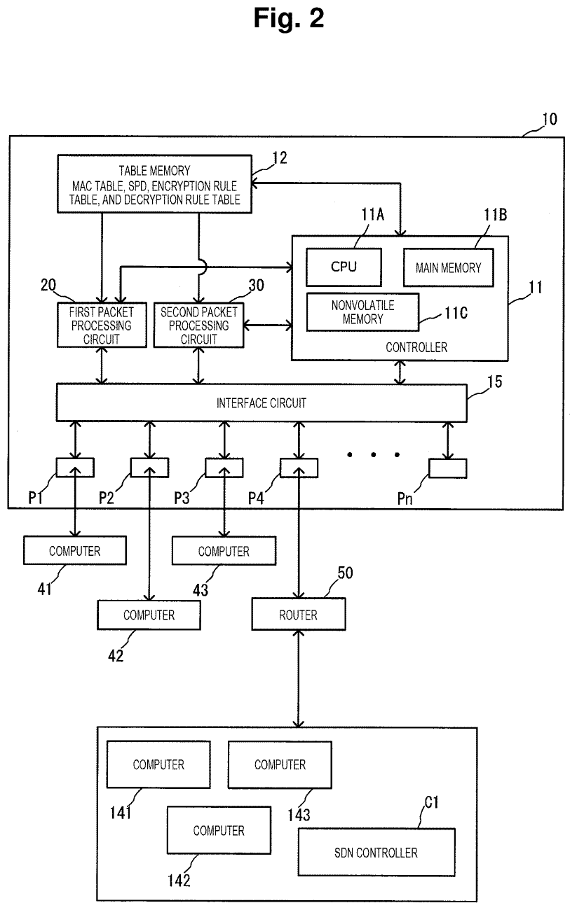

As illustrated in FIG. 2, the switch 10 includes a plurality of ports P1 to Pn (n is the total number of ports), a controller 11, a table memory 12, an interface circuit 15, a first packet processing circuit 20, and a second packet processing circuit 30. The numerical parts of the reference signs of the ports P1 to Pn are defined as the port numbers of the ports. For example, the port number of the port P3 is “3”. The ports P1 to Pn are also collectively referred to as a port P.

The computers 41 to 43 are connected to the ports P1 to P3, respectively. The router 50 is connected to the port P4. It is assumed that computers are also connected to the other ports P.

The controller 11 includes a central processing unit (CPU) 11A, a main memory 11B of the CPU 11A, and a nonvolatile memory 11C that stores a program and data for operating the CPU 11A as described later. The controller 11 (CPU 11A that executes the program) controls the entire switch 10 and performs an operation to be described later.

The table memory 12 is configured by a random access memory (RAM), and stores tables such as a media access control address (MAC) table, a security policy database (SPD), an encryption rule table, and a decryption rule table. Each table is managed by the controller 11 and the SDN controller C1. For example, the SDN controller C1 communicates with the controller 11 via the network NW, the router 50, the port P4, the interface circuit 15, and the like, and manages the contents of the SPD via the controller 11. The controller 11 and the SDN controller C1 desirably perform encrypted communication by a VPN or the like. The controller 11 and the SDN controller C1 may be connected by a dedicated line for security.

When packets are input from the computers 41 to 43 to the ports P1 to P3, the interface circuit 15 transfers the packets to the first packet processing circuit 20. When packets are input from the router 50 to the port P4, the interface circuit 15 transfers the packets to the second packet processing circuit 30.

The first packet processing circuit 20 performs processing of transferring the packets from the interface circuit 15 to the ports P corresponding to transmission destinations. The transmission destinations include the computers 141 to 143. Details of the first packet processing circuit 20 will be described later.

The second packet processing circuit 30 performs processing of transferring the packets from the interface circuit 15 to the ports P corresponding to transmission destinations. The ports P as transfer destinations are mainly the ports P1 to P3. Details of the second packet processing circuit 30 will be described later.

The table memory 12, the first packet processing circuit 20, and the second packet processing circuit 30 may be provided in, for example, an application specific integrated circuit (ASIC) or a field-programmable gate array (FPGA). In this case, the table memory 12 is configured in a block random access memory (BRAM) or a static random access memory (SRAM) on the ASIC or the FPGA.

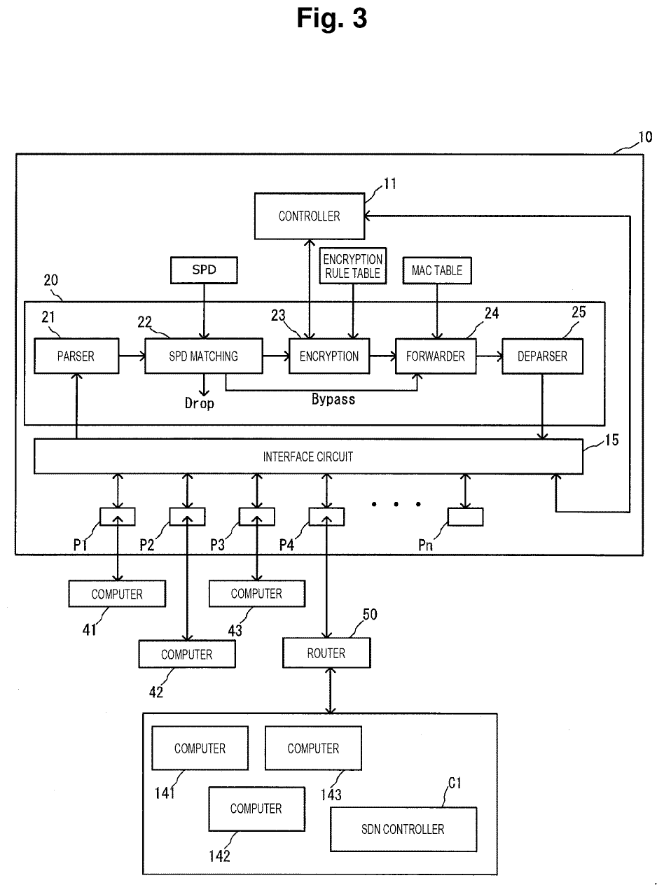

As illustrated in FIG. 3, the first packet processing circuit 20 includes a parser module 21, an SPD matching module 22, an encryption module 23, a forwarder module 24, and a deparser module 25.

The parser module 21 analyzes a packet from the interface circuit 15 and generates header specifying information specifying the range of a header in the entire packet. The parser module sends the packet to the SPD matching module 22 together with the header specifying information. Hereinafter, it is assumed that the header of the packet is specified by the header specifying information sent together with the header.

The SPD matching module 22 refers to the SPD using, as keys, a set of IP addresses of a transmission source and a transmission destination and a type of a communication protocol included in the header of the packet. The SPD indicates a correspondence relationship among a set of IP addresses of a transmission source and a transmission destination, a type of a communication protocol, and an action. The action includes “encryption” and “bypass”.

In the SPD, the action of “encryption” is set corresponding to a combination of a set of IP addresses of a transmission source and a transmission destination set as a target of VPN communication and a type of a communication protocol of communication between the transmission source and the transmission destination. In the SPD, the action of “bypass” is set corresponding to a combination of a set of IP addresses of a transmission source and a transmission destination set as a non-target of VPN communication and a type of a communication protocol of communication between the transmission source and the transmission destination. Note that, regarding the SPD and keys at the time of SPD reference, a type of a communication protocol may be appropriately omitted.

The SPD matching module 22 obtains, from the SPD, an action corresponding to the combination matching the keys from the SPD. When the acquired action is “encryption”, the SPD matching module 22 sends the packet and the header specifying information to the encryption module 23. When the acquired action is “bypass”, the SPD matching module 22 sends the packet and the header specifying information to the forwarder module 24. In a case where there is no combination matching the keys, the SPD matching module 22 discards the packet to be processed.

The encryption module 23 transmits the packet from the SPD matching module 22 to the controller 11 (CPU 11A) together with an encryption instruction. At this time, the encryption module 23 refers to the encryption rule table. The encryption rule table indicates a correspondence relationship between a set of IP addresses of a transmission source and a transmission destination and an encryption rule. The encryption rule is information including a type of an encryption algorithm and an encryption key. The encryption module 23 acquires an encryption rule corresponding to the set of IP addresses of the transmission source and the transmission destination included in the header of the packet from the encryption rule table, and supplies the rule to the controller 11. The encryption module 23 holds predetermined information such as an IP address and a MAC address in the header of the packet in a memory or the like.

The controller 11 encrypts the packet from the encryption module 23 on the basis of the encryption rule from the encryption module 23. The controller 11 returns the packet after the encryption as an encrypted packet to the encryption module 23.

The encryption module 23 generates a new header on the basis of the predetermined information, and encapsulates the encrypted packet from the controller 11 with the generated new header added. The encryption module 23 sends the encapsulated encrypted packet to the forwarder module 24 together with header specifying information specifying the range of the new header. The new header includes encryption information indicating that the subsequent packet is encrypted.

The forwarder module 24 transfers the packet and its header specifying information received from the module 22 or 23 to the port P with the port number corresponding to the MAC address of the transmission destination included in the header via the deparser module 25 and the interface circuit 15. The port number corresponding to the MAC address is specified with reference to a MAC table indicating a correspondence relationship between a MAC address and a port number (hereinafter, the same applies to specification of a port number).

The deparser module 25 deletes the header specifying information among the packet and the header specifying information transferred from the forwarder module 24 to the port P. That is, the header specifying information is not transferred to the port P. The deparser module 25 may generate a new header according to the type of the communication protocol included in the header. When a new header is generated, the deparser module 25 attaches the header to the packet and sends the packet to the port P.

The packet transferred to the port P by the forwarder module 24 is then transmitted to the transmission destination having the destination MAC address, and finally transmitted to the transmission destination having the destination IP address. By this transmission, VPN communication is implemented if the packet is an encapsulated encrypted packet, and normal communication is implemented if the packet is not encrypted. Thus, both normal communication and VPN communication are performed depending on whether the packet is encrypted.

The encryption of a packet and the transfer processing to the port P as described above are similarly performed on the switch 110 side.

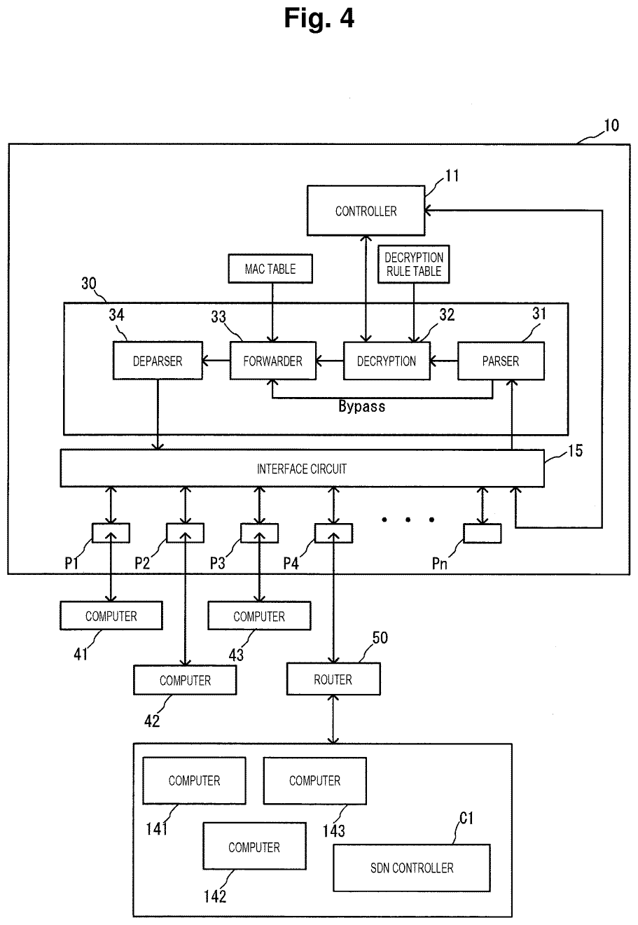

As illustrated in FIG. 4, the second packet processing circuit 30 includes a parser module 31, a decryption module 32, a forwarder module 33, and a deparser module 34.

The parser module 31 analyzes a packet from the interface circuit 15 and generates header specifying information specifying the range of a header in the entire packet. In a case where the header includes encryption information, the parser module 31 sends the packet to the decryption module 32 together with the header specifying information. The packet in this case is an encapsulated encrypted packet from one of the computers 141 to 143, which has been encrypted by the switch 110 in a manner similar to the above method and transmitted by a VPN. In a case where the header includes no encryption information, the parser module 31 determines that this packet has not been transmitted through communication by a VPN. In this case, the parser module 31 bypasses this packet to the forwarder module 33 together with the header specifying information.

The decryption module 32 transmits the encrypted packet obtained by excluding the header in the packet from the parser module 31 to the controller 11. At this time, the decryption module 32 refers to the decryption rule table. The decryption rule table indicates a correspondence relationship between a set of IP addresses of a transmission source and a transmission destination and a decryption rule. The decryption rule is information including a type of a decryption algorithm and a decryption key. The decryption module 32 acquires a decryption rule corresponding to a set of IP addresses of a transmission source and a transmission destination included in the header of the packet from the decryption rule table, and supplies the decryption rule to the controller 11.

The controller 11 decrypts the encrypted packet from the decryption module 32 on the basis of the decryption rule from the decryption module 32. The controller 11 returns the packet after the decryption as a decrypted packet to the decryption module 32. The decryption module 32 sets the returned decrypted packet and the header attached to the head of the packet (hereinafter, also referred to as the head header) as one packet, and sends the packet to the forwarder module 33 together with the header specifying information from the parser module 31.

The forwarder module 33 transfers the packet from the parser module 31 or the decryption module 32 to the port P with the port number corresponding to the MAC address included in the header via the deparser module 34 and the interface circuit 15.

In a case where the header (the head header in a case where the packet includes the decrypted packet) includes encryption information, the deparser module 34 deletes the head header and the header specifying information. As a result, only the decrypted packet is transferred to the port P. In a case where the header includes no encryption information, the deparser module 34 deletes the header specifying information. The decrypted packet or the unencrypted packet transferred to the port P is transmitted to any one of the computers 41 to 43 as a transmission destination. As a result, in the former case, decryption and reception of the packet transmitted by the VPN are implemented, and in the latter case, normal communication without encryption is performed.

As described above, the switch 10 according to the present embodiment includes a first circuit (the first packet processing circuit 20 and the CPU 11A) that encrypts a packet from any one of the computers 41 to 43 as one of VPN peers and transmits the packet after the encryption to any one of the computers 141 to 143 as the other of the VPN peers via the network NW to transmit the packet by a VPN. The devices constituting the VPN peers are not limited to computers, and may be communication devices such as other switches or routers. With such a configuration, since the packet is encrypted by the switch 10, encryption in the VPN is implemented without use of CPU resources of as an application server or the like. As a result, inconvenience such as a decrease in execution efficiency of another application by the CPU resources is suppressed.

The switch 10 further includes a second circuit (the second packet processing circuit 30 and the CPU 11A) that decrypts a packet transmitted by a VPN from one of the computers 141 to 143 as the other of the VPN peers via the network NW and transmits the packet after the decryption to one of the computers 41 to 43 as the one of the VPN peers. With such a configuration, since the packet is decrypted by the switch 10, decryption in the VPN is implemented without use of CPU resources of as an application server or the like. The devices constituting the VPN peers are not limited to computers, and may be communication devices such as other switches or routers.

Furthermore, the first circuit receives a packet from a first port P connected to any one of the computers 41 to 43 as the one of the VPN peers, and determines whether the received packet is a target of communication by a VPN with reference to an SPD. When it is determined that the packet is a target of communication by the VPN, the first circuit encrypts the packet and transfers the packet after the encryption to a second port P connected to the network NW to which each of the computers 141 to 143 as the other of the VPN peers is connected. In addition, the first circuit transfers the packet to the second port P without encrypting the packet when it is determined that the packet is not a target of communication by the VPN. With such a configuration, the switch 10 can also have a non-VPN transfer function, which is a conventional packet transfer function.

Furthermore, the present embodiment prepares a plurality of types of VPNs having different combinations of VPN peers and/or different encryption or decryption methods, and thus the plurality of types of VPNs are aggregated in the switch 10. As a result, calculation resources for encryption and decryption in the site are aggregated in the switch 10, and thus the calculation resources for encryption and decryption are aggregated and more efficient. Note that, in the present embodiment, a plurality of sets of IP addresses of a transmission destination and a transmission source corresponding to “encryption” in the SPD are prepared, and/or different rules are set according to different sets of IP addresses of a transmission destination and a transmission source in the encryption and decryption rule tables, so that the plurality of types of VPNs are implemented, but a method of implementing the plurality of types of VPNs is arbitrary.

In the above embodiment, in a case where a packet received from the second port P is encrypted, the second circuit decrypts the packet and transfers the packet after the decryption to the first port P, and in a case where the packet received from the second port P is not encrypted, the second circuit transfers the packet to the first port P without decrypting the packet. As a result, the switch 10 can also have the non-VPN transfer function, which is a conventional packet transfer function.

In the above embodiment, encryption and decryption are performed by the CPU 11A that controls the operation of the switch 10, and thus the configuration for the encryption and decryption processing is easy. The encryption may be executed not by the CPU 11A but by the encryption module 23 of the first packet processing circuit 20. The decryption may be executed not by the CPU 11A but by the decryption module 32 of the second packet processing circuit 30.

The switch 10 is originally used as a communication device that relays packets transmitted and received between any one of the computers 41 to 43 and any one of the computers 141 to 143, that is, between VPN peers. Therefore, since encryption and decryption are performed without increasing the number of relay points of packets transmitted and received between VPN peers, it is possible to suppress a decrease in communication speed due to provision of a new relay point such as an application server. As described above, according to the present embodiment, a decrease in communication speed of communication by a VPN is suppressed.

Regarding communication of a VPN, it is conceivable that a server called a middle box is provided between a switch and a router, and a CPU of the middle box performs encryption and decryption for the VPN. However, in the present embodiment, such a middle box is unnecessary. The operability of a site and the power efficiency are improved. Furthermore, it is also possible to prevent a poor performance of a middle box from deteriorating the communication performance of the entire system.

### Second Embodiment

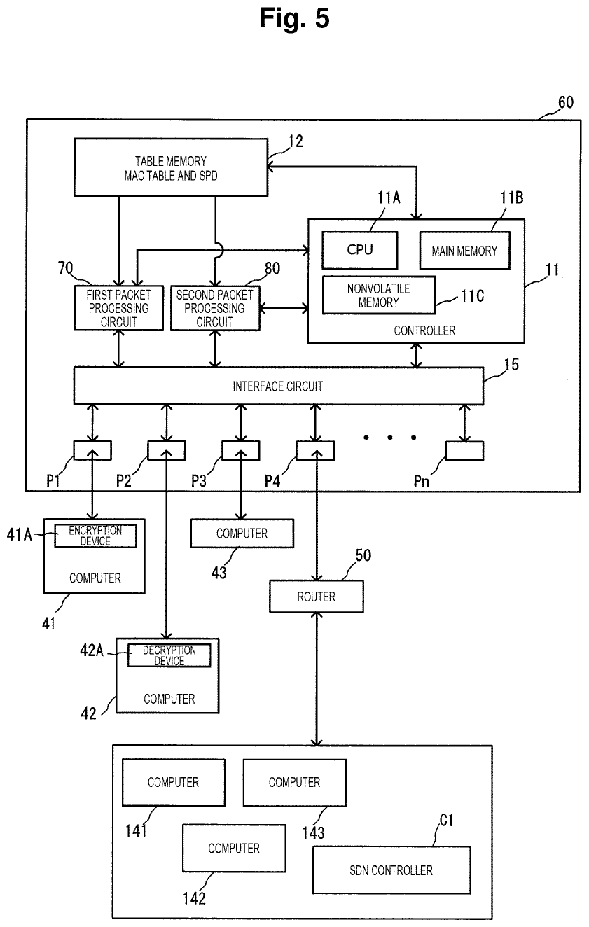

As illustrated in FIG. 5, a switch 60 according to the present embodiment includes a first packet processing circuit 70 and a second packet processing circuit 80 instead of the first packet processing circuit 20 and the second packet processing circuit 30 of the switch 10 according to the first embodiment. In addition, encryption and decryption of a packet in a VPN are respectively performed by an encryption device 41A and a decryption device 42A respectively provided in the computers 41 and 42. The encryption device 41A and the decryption device 42A are each configured by an ASIC or an FPGA mounted on a smart NIC or the like, and are connected to the switch 60. The encryption device 41A and the decryption device 42A can each be configured by, for example, an ASIC or an FPGA of a network interface, and may be provided in an ASIC or an FPGA of a smart NIC of the router 50. Hereinafter, differences between the first embodiment and the second embodiment will be mainly described.

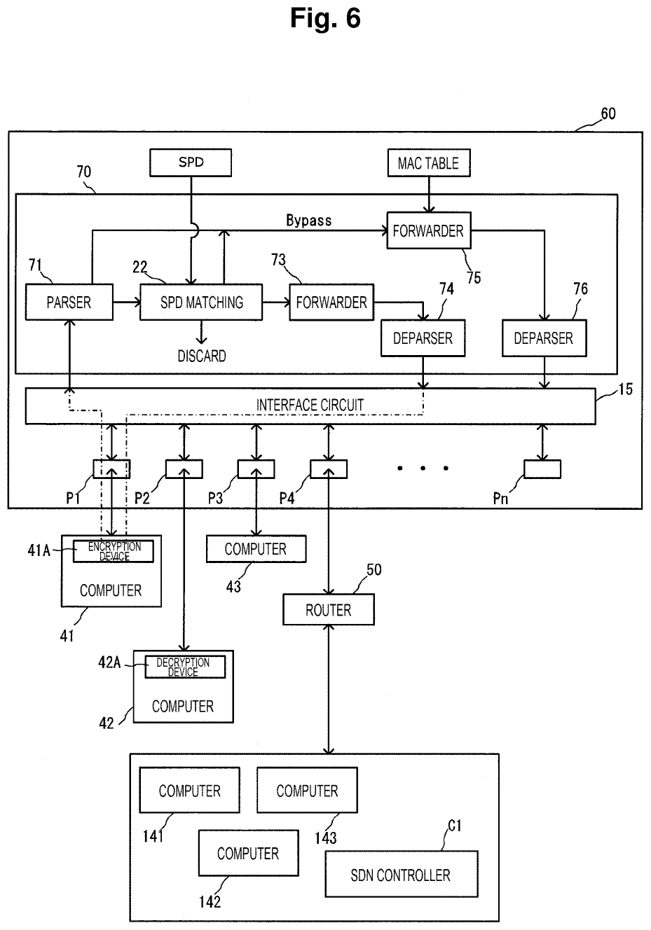

As illustrated in FIG. 6, the first packet processing circuit 70 includes a parser module 71, an SPD matching module 22, forwarder modules 73 and 75, and deparser modules 74 and 76.

Packets from the ports P1 to P3 are input to the parser module 71. In a case where the encryption device 41A is configured by a network interface of a device other than the computer 41, such as an NIC of the router 50, a packet from the port P connected to the network interface is also input to the parser module 71 (details will be described later). With such a configuration, not only a packet before encryption but also a packet after encryption is supplied to the parser module 71.

The parser module 71 analyzes a packet from the interface circuit 15 similar to that of the first embodiment, and generates header specifying information specifying the range of a header in the entire packet. The parser module 71 also determines whether the header includes encryption information.

In a case where the header includes no encryption information, the parser module 71 sends the packet and the header specifying information to the SPD matching module 22. The SPD matching module 22 has a configuration similar to that of the first embodiment, and acquires an action corresponding to the combination matching the keys from the SPD. When the acquired action is “encryption”, the SPD matching module 22 sends the packet to the forwarder module 73 together with the header specifying information. When the acquired action is “bypass”, the SPD matching module 22 sends the packet and the header specifying information to the forwarder module 75. In a case where there is no combination matching the keys, the SPD matching module 22 discards the packet to be processed.

The forwarder module 73 sends the packet and the header specifying information to the port P with the port number to which the encryption device 41A is connected (here, the port P1) via the deparser module 74 and the interface circuit 15. The deparser module 74 deletes the header specifying information and sends the packet to the port P together with an encryption instruction. The packet and the encryption instruction sent to the port P are transmitted to the encryption device 41A.

Upon receiving the packet and the encryption instruction, the encryption device 41A refers to an encryption rule table stored therein and encrypts the packet. The encryption device 41A acquires an encryption rule corresponding to a set of IP addresses of a transmission source and a transmission destination included in the header of the packet from the encryption rule table, and encrypts the packet on the basis of the acquired encryption rule. The encryption device 41A generates a new header on the basis of predetermined information such as an IP address and a MAC address in the header of the packet before the encryption and adds the header to the encrypted packet to encapsulate the encrypted packet. The new header also includes encryption information. The encryption device 41A sets the encapsulated encrypted packet and the new header as one packet of reply to the encryption instruction and sends the packet to the port P1 connected to the encryption device 41A, that is, the computer 41. The packet as a reply to the encryption instruction, which has been sent to the port P1, is sent to the parser module 71 via the interface circuit 15. As in the first embodiment, the encryption rule table is managed by the SDN controller C1 via the network NW, the port P, and the like.

In a case where the header includes encryption information, the parser module 71 sends the encapsulated encrypted packet and header specifying information obtained by analyzing the packet to the forwarder module 75.

The forwarder module 75 transfers the packet and the header specifying information from the parser module 71 or the SPD matching module 22 to the port P with the port number corresponding to the MAC address of the transmission destination included in the header via the deparser module 76 and the interface circuit 15.

The deparser module 76 deletes the header specifying information among the packet and the header specifying information transferred from the forwarder module 75 to the port P. The deparser module 76 may generate a new header according to a type of a communication protocol included in the header. When a new header is generated, the deparser module 76 attaches the header to the packet and sends the packet to the port P.

The packet transferred to the port P by the forwarder module 75 is transmitted to the transmission destination having the destination MAC address, and finally transmitted to the transmission destination having the destination IP address. By this transmission, VPN communication is implemented if the packet is an encapsulated encrypted packet, and normal communication is implemented if the packet is not encrypted. Thus, both normal communication and VPN communication are performed depending on whether the packet is encrypted.

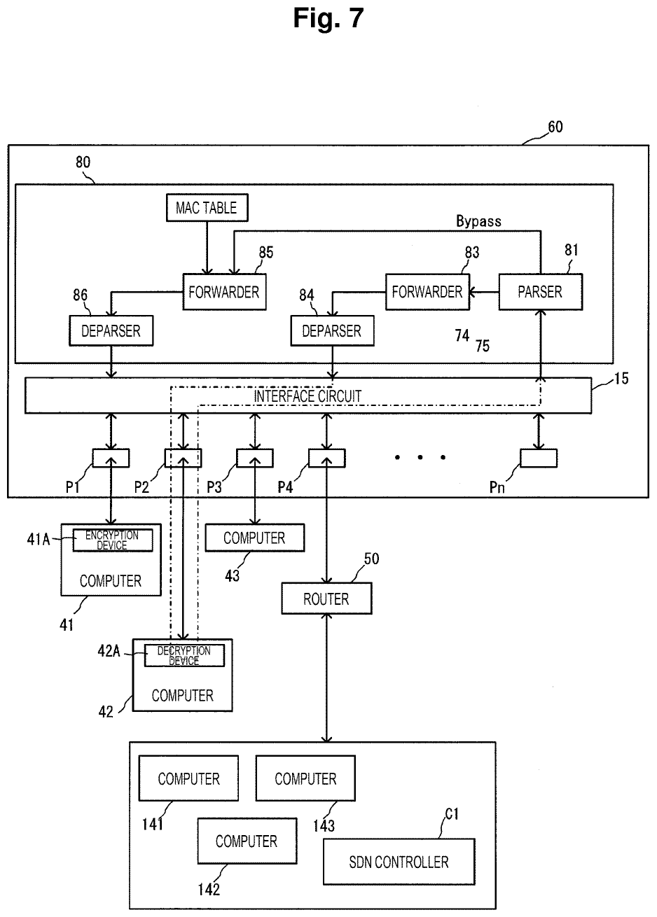

As illustrated in FIG. 7, the second packet processing circuit 80 includes a parser module 81, forwarder modules 83 and 85, and deparser modules 84 and 86.

A packet from the port P4 is input to the parser module 81 via the interface circuit 15. A packet (packet after decryption to be described later) from the port P2 to which the decryption device 42A, that is, the computer 42 is connected is also input to the parser module 81 via the interface circuit 15. In a case where the decryption device 42A is configured by a network interface of a device other than the computer 42, such as an NIC of the router 50, a packet from the port P connected to the network interface is input to the parser module 81 via the interface circuit 15 (details will be described later). With such a configuration, not only a packet before decryption but also a packet after decryption is supplied to the parser module 81.

The parser module 81 analyzes a packet from the interface circuit 15 and generates header specifying information specifying the range of a header in the entire packet. The parser module 81 also determines whether the header includes encryption information.

In a case where the header includes encryption information, the parser module 81 sends the packet (encapsulated encrypted packet) and the header specifying information to the forwarder module 83.

The forwarder module 83 sends the packet and the header specifying information to the port P2, which is the port P with the port number corresponding to the MAC address of the decryption device 42A, via the deparser module 84. The deparser module 84 deletes the header specifying information and sends the packet to the port P2 together with a decryption instruction. The packet (encapsulated encrypted packet) and the decryption instruction sent to the port P2 are transmitted to the decryption device 42A.

Upon receiving the packet and the decryption instruction, the decryption device 42A refers to a decryption rule table stored therein and decrypts the encrypted packet in the packet. The decryption device 42A acquires a decryption rule corresponding to a set of IP addresses of a transmission source and a transmission destination included in the header of the packet from the decryption rule table, and decrypts the encrypted packet on the basis of the acquired decryption rule. The decryption device 42A sends, as a reply to the decryption instruction, the decrypted encrypted packet to the port P2 connected to the decryption device 42A, that is, the computer 42. The packet sent to the port P2 as a reply to the decryption instruction is sent to the parser module 81 via the interface circuit 15. As in the first embodiment, the decryption rule table is managed by the SDN controller C1 via the network NW, the port P, and the like.

In a case where the header includes no encryption information, the parser module 81 sends the header specifying information to the forwarder module 85.

The forwarder module 85 transfers the packet and the header specifying information from the parser module 81 to the port P with the port number corresponding to the MAC address of the transmission destination included in the header via the deparser module 86.

The deparser module 86 deletes the header specifying information among the packet and the header specifying information transferred from the forwarder module 85 to the port P. The deparser module 86 may generate a new header according to a type of a communication protocol included in the header. When a new header is generated, the deparser module 86 attaches the header to the packet and sends the packet to the port P.

The packet transferred to the port P by the forwarder module 85 is transmitted to the transmission destination having the destination MAC address, and finally transmitted to the transmission destination having the destination IP address. By this transmission, VPN communication is implemented if the packet is a decrypted packet, and normal communication is implemented if the packet is not originally encrypted. Thus, both normal communication and VPN communication are performed depending on whether the packet is encrypted.

According to the present embodiment, the switch 60 according to the present embodiment includes a first circuit (first packet processing circuit 70) that causes the encryption device 41A connected to the switch 60, that is, an ASIC or an FPGA of a network interface to encrypt a packet from any one of the computers 41 to 43 as one of VPN peers, and transmits the packet after the encryption to any one of the computers 141 to 143 as the other of the VPN peers via the network NW to transmit the packet by a VPN.

The switch 60 further includes a second circuit (second packet processing circuit 80) that causes the decryption device 42A connected to the switch 60, that is, an ASIC or an FPGA of a network interface to decrypt a packet transmitted by a VPN from one of the computers 141 to 143 as the other of the VPN peers via the network NW, and transmits the packet after the decryption to one of the computers 41 to 43 as the one of the VPN peers.

With the configuration as described above, it is possible to obtain effects similar to those of the first embodiment, and since the CPU 11A of the switch 60 is not used for encryption and decryption in communication by the VPN, the throughput and power consumption in the switch 60 are reduced accordingly.

### MODIFIED EXAMPLES

Various modifications can be made to the above embodiments. For example, as a port P included in a switch, a port connected to another network such as an intra-company local area network (LAN) may be prepared. As a port P, a VPN-dedicated or non-VPN-dedicated port may be prepared. As a VPN, a VPN other than an IPsec-VPN may be adopted. The switches can be switching hubs, network switches, or the like.

The present invention is not limited to the above embodiments and modified examples. For example, the present invention includes various modifications to the above embodiments and modified examples that can be understood by those skilled in the art within the scope of the technical idea of the present invention. The configurations described in the above embodiments and modified examples can be appropriately combined without being 18 inconsistent. In addition, it is also possible to delete any configuration among the above configurations.

### SUPPLEMENT

Configurations disclosed in the present specification, which include the above embodiments and modified examples as examples, will be exemplified below.

### Supplement 1

A switch configured to relay data transmitted and received between a first combination of virtual private network (VPN) peers, the switch including a first circuit that encrypts 1-1 data from a 1-1 device as one of the first combination of VPN peers or causes an application specific integrated circuit (ASIC) or a field-programmable gate array (FPGA) of a network interface connected to the switch to encrypt the 1-1 data, and transmits the 1-1 data after the encryption to a 1-2 device as another of the first combination of VPN peers via a network to transmit the 1-1 data by a VPN.

### Supplement 2

The switch according to supplement 1, further including a second circuit that decrypts 1-2 data transmitted by a VPN from the 1-2 device via the network or causes an ASIC or an FPGA of a network interface connected to the switch to decrypt the 1-2 data, and transmits the 1-2 data after the decryption to the 1-1 device.

### Supplement 3

The switch according to supplement 1 or 2, wherein the first circuit receives the 1-1data from a first port connected to the 1-1 device, determines whether the received 1-1 data is a target of communication by a VPN, encrypts the 1-1 data or causes the ASIC or the FPGA to encrypt the 1-1 data and transfers the 1-1 data after the encryption to a second port connected to the network when it is determined that the 1-1 data is a target of communication by the VPN, and transfers the 1-1 data to the second port without encrypting the 1-1 data when it is determined that the 1-1 data is not a target of communication by the VPN.

### Supplement 4

The switch according to any one of supplements 1 to 3, wherein the first circuit encrypts second data from a 2-1 device as one of a second combination of VPN peers according to a second rule different from a rule for encrypting the 1-1 data or causes an ASIC or an FPGA of a network interface connected to the switch to encrypt the second data according to the second rule, and transmits the second data after the encryption to a 2-2 device as another of the second combination of VPN peers via the network to transmit the second data by a VPN.

### Supplement 5

The switch according to any one of supplements 2 to 4, wherein the second circuit decrypts the 1-2 data received from a second port connected to the network or causes the ASIC or the FPGA of the network interface connected to the switch to decrypt the 1-2 data and transfers the 1-2 data after the decryption to a first port connected to the 1-1 device in a case where the 1-2 data is encrypted, and transfers the 1-2 data received from the second port to the first port without decrypting the 1-2 data in a case where the 1-2 data is not encrypted.

### Supplement 6

The switch according to any one of supplements 1 to 5, wherein the first circuit is configured to encrypt the 1-1 data, and includes a CPU that controls an operation of the switch and encrypts the 1-1 data.

### REFERENCE SIGNS LIST

10, 60, 110 Switch
11 Controller
11A CPU
12 Table memory
15 Interface circuit
20 First packet processing circuit
21 Parser module
22 SPD matching module
23 Encryption module
24 Forwarder module
25 Deparser module
30 Second packet processing circuit
31 Parser module
32 Decryption module
33 Forwarder module
34 Deparser module
41 to 43 Computer
41A Encryption device
42A Decryption device
50 Router
60 Switch
70 First packet processing circuit
71 Parser module
73 Forwarder module
74 Deparser module
75 Forwarder module
76 Deparser module
80 Second packet processing circuit
81 Parser module
83 Forwarder module
84 Deparser module
85 Forwarder module
86 Deparser module
110 Switch
141 to 143 Computer
150 Router
A Site
B Site
C Site
C1 SDN controller
P, P1 to Pn Port

1-6. (canceled)

7. A switch configured to relay data between a first combination of virtual private network (VPN) peers, the switch comprising:
a first circuit configured to:
encrypt 1-1 data or cause an application specific integrated circuit (ASIC) or a field-programmable gate array (FPGA) of a network interface connected to the switch to encrypt the 1-1 data, wherein the 1-1 data is from a 1-1 device that is one of the first combination of VPN peers; and
transmit the 1-1 data that has been encrypted to a 1-2 device via a network to transmit the 1-1 data by a VPN, wherein the 1-2 device is another one of the first combination of VPN peers.

8. The switch according to claim 7, further comprising a second circuit configured to:
decrypt 1-2 data transmitted by the VPN from the 1-2 device via the network; and
transmit the 1-2 data that has been decrypted to the 1-1 device.

9. The switch according to claim 7, further comprising a second circuit configured to:
cause the ASIC or the FPGA of the network interface connected to the switch to decrypt 1-2 data transmitted by the VPN from the 1-2 device via the network; and
transmit the 1-2 data that has been decrypted to the 1-1 device.

10. The switch according to claim 7, wherein the first circuit is further configured to:
receive the 1-1 data from a first port connected to the 1-1 device;
determine that the 1-1 data is a target of communication by a VPN; and
transfer the 1-1 data that has been encrypted to a second port connected to the network.

11. The switch according to claim 7, wherein the first circuit is further configured to:
encrypt second data from a 2-1 device according to a second rule different from a first rule for encrypting the 1-1 data, wherein the 2-1 device is one of a second combination of VPN peers; or
cause the ASIC or the FPGA of the network interface connected to the switch to encrypt the second data according to the second rule.

12. The switch according to claim 11, wherein the first circuit is further configured to:
transmit the second data that has been encrypted to a 2-2 device via the network to transmit the second data by a VPN, wherein the 2-2 device is another one of the second combination of VPN peers.

13. The switch according to claim 8, further comprising a second circuit configured to:
decrypts 1-2 data received from a second port connected to the network or cause the ASIC or the FPGA of the network interface connected to the switch to decrypt the 1-2 data and transfer the 1-2 data that has been decrypted to a first port connected to the 1-1 device when the 1-2 data is encrypted; and
transfer the 1-2 data received from the second port to the first port without decrypting the 1-2 data when the 1-2 data is not encrypted.

14. The switch according to claim 7, wherein the first circuit is configured to encrypt the 1-1 data, and includes a CPU that is configured to control an operation of the switch and encrypt the 1-1 data.

15. A switch configured to relay data between a first combination of virtual private network (VPN) peers, the switch comprising:
a first circuit configured to:
receive 1-1 data from a first port connected to a 1-1 device that is one of the first combination of VPN peers;
determine whether the 1-1 data is a target of communication by a VPN;
in response to determining that the 1-1 data is the target of communication by the VPN, encrypt the 1-1 data or cause an application specific integrated circuit (ASIC) or a field-programmable gate array (FPGA) of a network interface connected to the switch to encrypt the 1-1 data and transfer the 1-1 data that has been encrypted to a second port connected to a network; and
in response to determining that the 1-1 data is not the target of communication by the VPN, transfer the 1-1 data to the second port without encrypting the 1-1 data.

16. The switch according to claim 15, further comprising a second circuit configured to:
decrypts 1-2 data received from a second port connected to the network or cause the ASIC or the FPGA of the network interface connected to the switch to decrypt the 1-2 data and transfer the 1-2 data that has been decrypted to a first port connected to the 1-1 device when the 1-2 data is encrypted; and
transfer the 1-2 data received from the second port to the first port without decrypting the 1-2 data when the 1-2 data is not encrypted.

17. The switch according to claim 15, wherein the first circuit is further configured to:
encrypt second data from a 2-1 device according to a second rule different from a first rule for encrypting the 1-1 data, wherein the 2-1 device is one of a second combination of VPN peers; or
cause the ASIC or the FPGA of the network interface connected to the switch to encrypt the second data according to the second rule.

18. The switch according to claim 17, wherein the first circuit is further configured to:
transmit the second data that has been encrypted to a 2-2 device via the network to transmit the second data by a VPN, wherein the 2-2 device is another one of the second combination of VPN peers.

19. The switch according to claim 15, wherein the first circuit is configured to encrypt the 1-1 data, and includes a CPU that is configured to control an operation of the switch and encrypt the 1-1 data.
